(19) United States
(12) Patent Application Publication
(10) Pub. No.: US 2010/0312825 A1
(43) Pub. Date: Dec. 9, 2010

(54) SYSTEM, METHOD AND APPARATUS FOR LOCATING A MISSING PERSON

(76) Inventor: Tad A. Camp, Largo, FL (US)

Correspondence Address: LARSON AND LARSON, 11199 69TH STREET NORTH, LARGO, FL, 33773, US

(21) Appl. No.: 12/479,029

(22) Filed: Jun. 5, 2009

(51) Int. Cl. G06F 15/16

(52) U.S. Cl. 709/203

(57) ABSTRACT

An application for a database system having typical and specialized data related to a person/object that is maintained in case of an emergency such as the person getting lost or abducted. The invention includes secure access to the data by a custodian/customer and/or law enforcement agencies when and if something happens to the person/object.

### FIELD OF THE INVENTION

This invention relates to the field of finding missing persons and more particularly to a system, method and apparatus for capturing and providing specialized data during the time of need.

### BACKGROUND

There have been many notorious cases of missing people, adult and children. The kidnapping of Chas. A. Lindbergh, Jr. from Hopewell, N.J. in March of 1932 is a well known case of a missing child. As for adults, does anybody know the whereabouts of Jimmy Hoffa? Although there are many notorious cases, thousands of lesser known individuals go missing every year. The National Center for Missing and Exploited Children was established in 1984 for the sole purpose of finding missing children. This organization claims that 800,000 American children are reported missing every year, of which 200,000 are abducted. Although many of these wind up being abductions by family members (e.g., a byproduct of a divorce), this organization estimates that 58,000 are abducted by non-family members and around 115 children are the subject of more serious abductions resulting in request for ransom, death or never returned.

According to the Federal Bureau of Investigation, the first two to three hours following abduction are the most critical to that person's return. In this time it is imperative that accurate and up-to-date data be provided and promptly disseminated to the community and/or law enforcement authorities. A system called “Amber Alert” exists to automatically disseminate a picture, information about the child, whereabouts and description of the suspect (if known) to a wide geographic region. This system was named after Amber Hagerman who was abducted at age 9. A similar system called, Silver Alert, is in place for missing senior citizens, perhaps those that suffer from Alzheimer's disease.

Unfortunately, the data critical in finding the missing person/child is not easily and quickly accessible at the time the person goes missing. Even if available, the data is often located in a multitude of places and in various formats. Pictures are often stored on computer hard drives, in frames or in a box. Dental records are often stored at a dental office and X-rays at a medical office. At the time of the loss, such data may or may not be available. For example, the close relatives are traveling, the doctor's office or dentist's office is closed, records have been archived and need to be retrieved, etc. This problem is further complicated by the fact that during such situations, persons concerned about the missing person are distraught and often unable to think clearly enough to gather such information. Precious time is lost when the authorities have to interview close relatives to accumulate the necessary data to establish a list of suspects and to disseminate sufficient information to assist in locating of the missing person/child.

What is needed is a system, method and apparatus that will accumulate, safely store and safely disseminate the needed data a soon as a missing person is identified.

### SUMMARY OF THE INVENTION

The present invention includes a database of typical and specialized data related to a person that is maintained in case of an emergency such as the person getting lost. The invention includes secure access to the data by a custodian/customer and/or law enforcement agencies when and if something happens to the person.

In one embodiment, a system for aiding in finding a missing person is disclosed including a server computer having a data storage area with a database of information stored in the data storage area. The information is related to a person, is organized into an account, and contains both typical information and specialized information. A client computer is operatively coupled to the server computer and has access to the information through a secured connection. Any possible client computer is anticipated including, but not limited to, a personal computer, a terminal device, a cell phone, a personal digital assistant (PDA), a web-enabled television, a web-enabled e-book, etc.

The typical information includes at least a name of the person, a data of birth of the person and a race of the person; and the specialized information includes at least five data selected from the group comprising images of family and friends of the person, X-ray images of the person, images of scars of the person, images of birthmarks of the person, images of tattoos of the person, images of piercings of the person, images of fingerprints of the person and images of dental records of the person.

In another embodiment, a method of providing a service that aids in finding the missing person is disclosed including providing a server computer having a data storage area and a database of information stored in the data storage area. The information is related to a person, organized into accounts, and contains typical information related to the person and specialized information related to the person. The method includes accepting a fee from a customer and in return for the fee, accepting the information from the customer and storing the information in an account for the customer. The typical information comprises at least a name of the person, a data of birth of the person and a race of the person; and the specialized information comprises at least five of: images of family and friends of the person, X-ray images of the person, images of scars of the person, images of birthmarks of the person, images of tattoos of the person, images of piercings of the person, images of fingerprints of the person and images of dental records of the person.

In another embodiment, a system for aiding in finding a missing person is disclosed including a server computer that has a data storage area in which a database of information is stored. The information is related to a person, is organized in an account and includes typical information and specialized information. The system includes a client computer operatively coupled to the server computer through a secured connection. Account maintenance software runs on the server and accepts the information from the client computer and stores the information in the database of information. The account maintenance software also provides the information from the database of information to authorized users of the account. The typical information includes at least a name of the person, a data of birth of the person and a race of the person while the specialized information includes X-ray images of the person, images of scars of the person, images of birthmarks of the person, images of fingerprints of the person and images of dental records of the person.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a system of the present invention.

FIG. 2 illustrates a typical logon/account creation user interface of the present invention.

FIG. 3 illustrates a typical account update user interface of the present invention.

FIG. 4 illustrates a typical data entry user interface of the present invention.

FIG. 5 illustrates a continuation of the data entry user interface of the present invention.

FIG. 6 illustrates another continuation of the data entry user interface of the present invention.

FIG. 7 illustrates a typical poster creation user interface of the present invention.

FIG. 8 illustrates a flow chart of the account access and data entry process of the present invention.

FIG. 9 illustrates a flow chart of child data entry process of the present invention.

FIG. 10 illustrates a flow chart of the data access process of the present invention.

FIG. 11 illustrates a flow chart of the poster generation process of the present invention.

FIG. 12 illustrates a perspective view of a cell phone showing an alert of the present invention.

FIG. 13 illustrates a plan view of a typical generated poster of the present invention.

FIG. 14 illustrates a front plan view of a typical user identification card of the present invention.

FIG. 15 illustrates a rear plan view of a typical user identification card of the present invention.

FIG. 16 illustrates a schematic view of a typical computer system of the present invention.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures. The present invention is generally described with respect to a missing person, and often to a missing child. This is done for clarity and brevity purposes only and the present invention is anticipated to apply to any missing person, animal and/or object, including, but not limited to, children, adults, senior citizens, ailing individuals, pets, vehicles and art work.

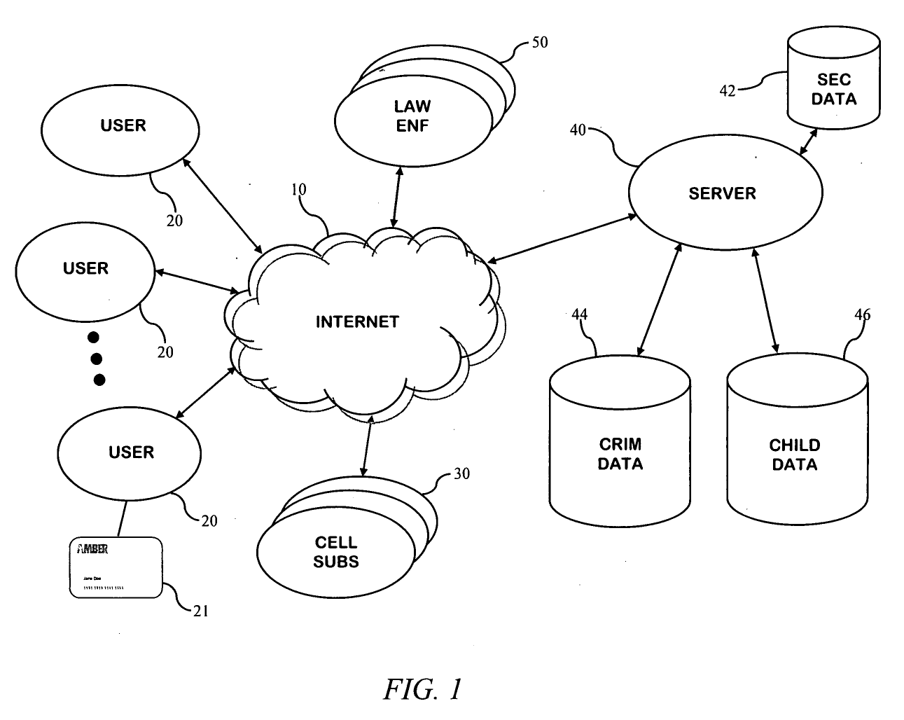

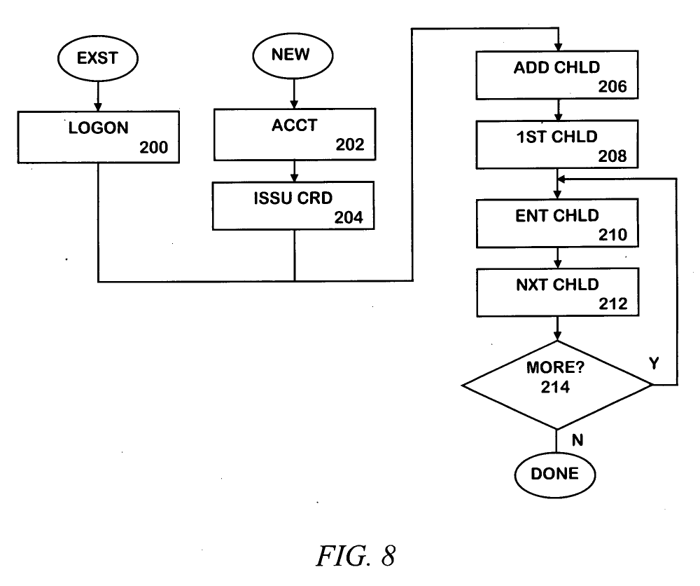

Referring to FIG. 1, a schematic view of a system of the present invention is shown. Although the present invention is intended to operate with any known network, it is preferred to operate with the Internet 10 (a.k.a the World Wide Web). The present invention provides any number of end users terminals 20 (e.g. personal computers) with a system for creating accounts, entering data, reviewing data, generating posters, providing information to authorities, etc. In some embodiments, the user is issued a card 21 containing access information (see FIGS. 8, 14 and 15). It is anticipated that the card 21 be convenient for carrying on the person of the parent or guardian. In some embodiments, the card includes a data stripe 24 (see FIG. 15) to improve access time.

The server 40 provides the services of the present invention. The server system includes security data 42 for authorizing access to the child data 46 associated with each particular user 20. In some embodiments, the server has access to a database of criminal records 44 (e.g., pedophile or sex offenders, felons). It is anticipated that any or all databases or storage areas 42/44/46 are locally interfaced to the server 20, remotely interfaced to the server 20 (e.g., Network Attached Storage—NAS) and/or remotely interfaced to the server 20 over a network, either a local area network or wide area network.

The server also interfaces to cell phone subscribers 30 through a connection provided by the cell phone service providers, as known in the industry. The cell phone service providers are interfaced to the server 40 with any known network or direct connection, as known in the industry. As shown in the example of FIG. 1, the cell phone service providers are interfaced to the server 40 through the Internet 10.

The server also interfaces to various law enforcement agencies 50. The law enforcement agencies 50 are interfaced to the server 40 with any known network or direct connection, as known in the industry. As shown in the example of FIG. 1, the law enforcement agencies 50 are interfaced to the server 40 through the Internet 10.

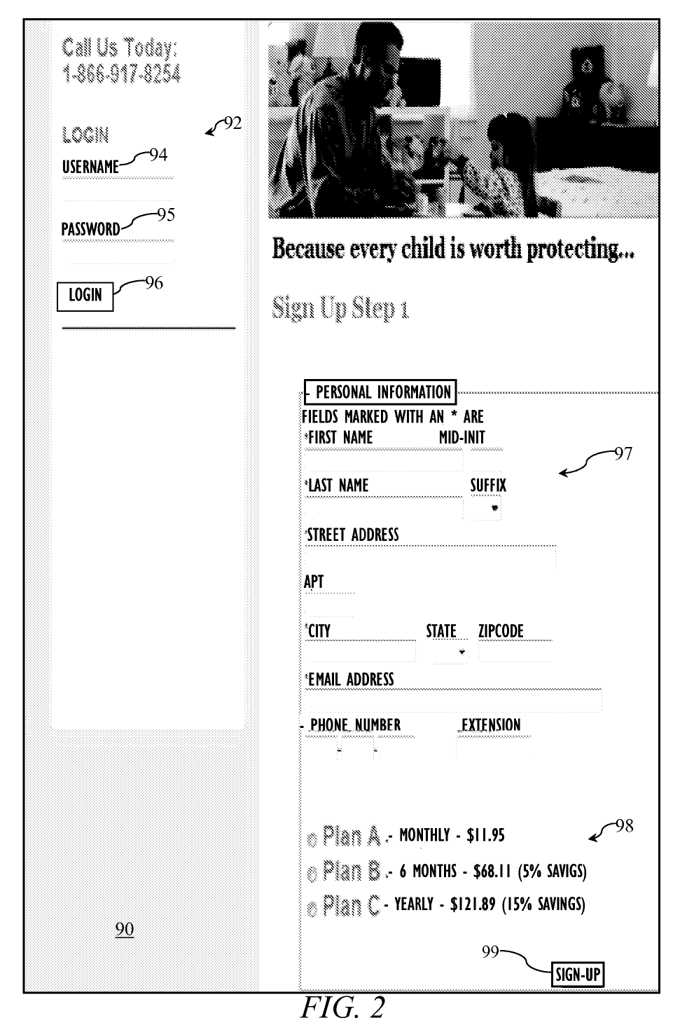

Referring to FIG. 2, a typical logon/account creation user interface 90 of the present invention is shown. The user interface examples and flow chart examples disclosed in the present application are examples of ways to implement the intended system, method and apparatus and are in no way meant to limit the present invention to any particular user interface or program flow.

The logon/account creation user interface 90 is accessed by a user 20 through a network (e.g., Internet 10). The user access the logon/account creation user interface 90 to create an account 97/98/99 or to logon to an existing account 92.

To logon to an existing account, the user enters typical logon security data 92 such as a username 94 and a password 95, and then selects the logon icon/button 96. Username/password security is well known for protecting access to data. Data from the security data 42 is used to authorize the users. Likewise, other security features are known such as presenting certain images to the user to prevent spoofing, requiring the user answer one or more pre-defined personal questions, identification of the user's computer (IP address), biometrics, etc. All known modes of security are recognized and included in the present invention.

To create a new account, the user enters personal information 97 such as name, address, phone number and email address. The user then selects a plan 98, indicating that they wish to pay a certain fee monthly, semi-annually, yearly, etc. For example, the user will pay $11.95 per month (dollar amounts and time periods are examples). Once the plan is selected, the user selects the “Sign Up” icon/button 99 to continue. Not shown are the payment entry user interfaces used to accept various forms of payment by the user such as credit cards, bank transfers, pre-paid check, etc. Such internet-based payment methods and user interfaces are well known in the industry and all of which are included here within.

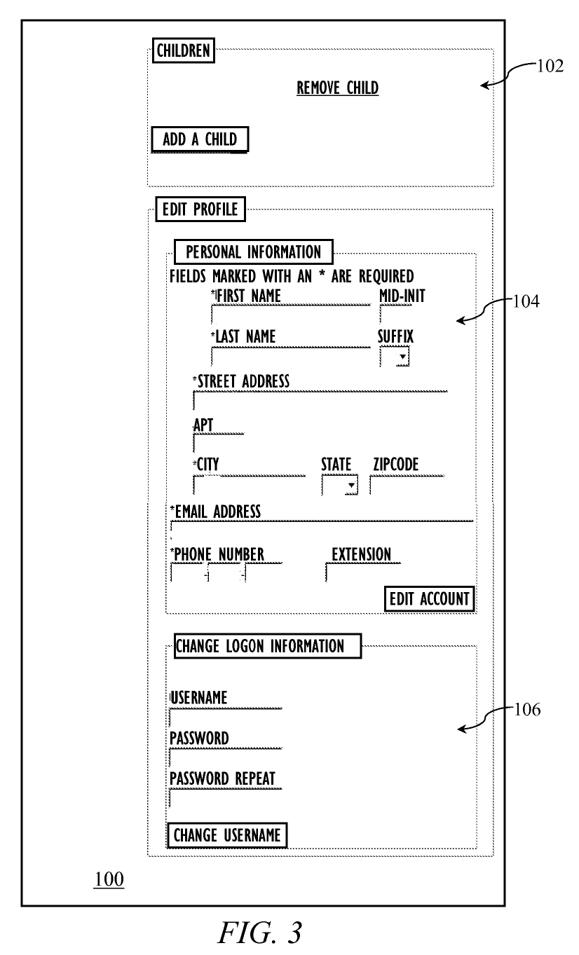

Referring to FIG. 3, a typical account update user interface 100 of the present invention is shown. This user interface is presented upon successful login 92 or successful sign up 97/98/99 and payment. This exemplary interface 100 has three main features: add an identity 102 (e.g., a child or senior citizen), edit profile 104 and change login 106. The user interface screens of the present invention relate to children, but it is anticipated that the present invention includes any class of person and/or object (e.g. vehicles, pets, unique objects, etc). The process or adding an identity 102 is described in subsequent user interface descriptions and flow charts.

Personal information 104 is shown and, if changes are needed (e.g., last name changes due to marriage, address changes), the edit account icon/button is selected.

Logon information 106 is shown and, if changes are needed (e.g., the user wants to change his or her password), the change username icon/button is selected. In some embodiments, the user is requested to change passwords at certain intervals, as known in the industry.

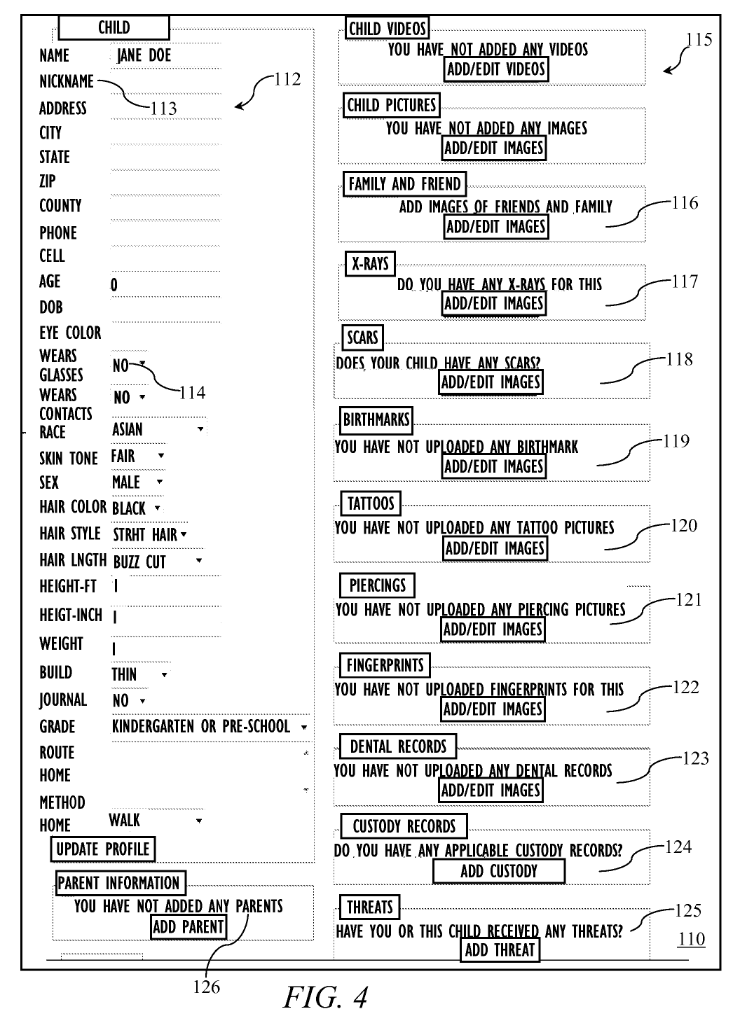

Referring to FIG. 4, a first section of a typical data entry user interface 110 of the present invention is shown. This typical user interface 110 is presented when the user adds an identity 102 (e.g. child). Much of the information 112 is typical information 112 commonly used in identifying the person (e.g. child). For example, it is known to identify a person by name, height, age, etc. The present invention builds upon the typical identification information 112 with other specialized data/information to improve on the breadth of data and, therefore, increase the chances of finding the person (e.g. child) once they are lost. For example, the person's nick name 113 and whether the person wears glasses 114. Also, it is known to have pictures or videos 115 of the person/child uploaded and related to the person/child's record. Note, the term “lost” includes the meaning of, not able to be found, thereby encompassing all possible reasons why a person or object is not able to be found including, but not limited to, the person/object is actually lost, the person was abducted, the object/pet was stolen, the person fled or is in hiding, the object was misplaced, the person died, the remains of a person/object are not recognizable, etc.

The present invention builds on this typical set of information with a unique and complete schema of specialized information for the person/child including, but not limited to, images of family and friends 116, X-ray images 117, images of scars 118, images of birthmarks 119, images of tattoos 120, images of piercings 121, images of fingerprints 122 and images of dental records 123. In such, the user selects an add/edit image icon/button and another user interface is provided to present any images currently saved and to upload new or replacement images along with any textual description of the images, as known in the art. There are many known user interfaces for uploading images and entering text, all are included here within.

Although a very delicate subject, there are many psychotic people in the world that abduct people/children and do nasty things. The information collected based upon the schema of the database 46 of the present invention is used, hopefully, to find the abducted person/child, but, at times is used to identify the remains or partial remains of such. In this, having ubiquitous access to dental records 123, X-rays 117, etc, are vital in identifying the remains.

Another type of information collected is specialized information regarding a parent 126, which is especially useful in cases in which an estranged parent abducts a child. The parent information 126 is collected in a similar user interface, garnering such data as name, address, phone number, vehicle information, as well as other identifying information such as images, tattoos, etc.

Much more data is captured in the user interfaces of the present invention. On the first section of a typical data entry user interface 110, there are provisions to accept specialized information related to custody records 124 (divorce decrees, custody decrees, prior/future custody schedules, etc) and information related to threats 125 (school bully, neighbor, etc).

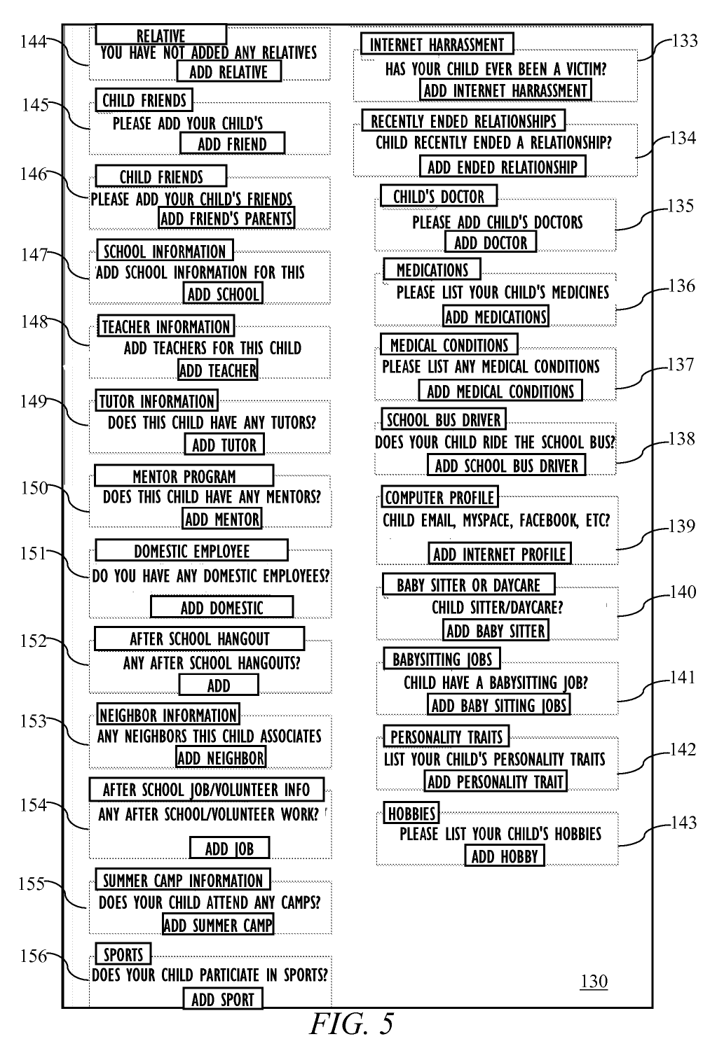

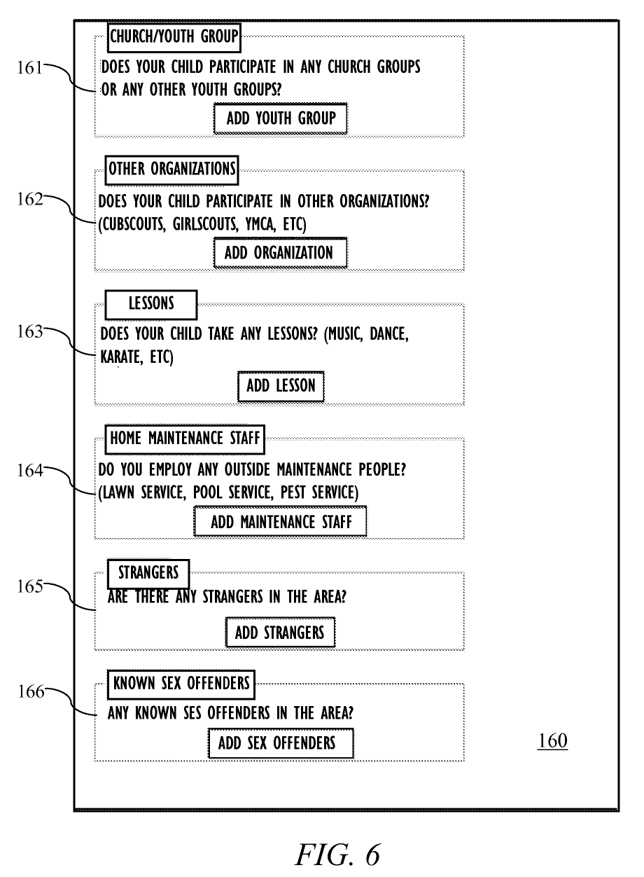

Referring to FIG. 5, a continuation of the data entry user interface 130 of the present invention is shown. This continuation screen is either a separate screen/web-page or a continuation accessed by scrolling. It contains more specialized information regarding the person/child. The list of specialized information includes, but is not limited to, Internet Harassment 133, recently ended relationships 134, lists of doctors 135, lists of medications 136, lists of medical conditions 137, names of school bus drivers 138, computer profiles 139, baby sitter information 140, baby sitting jobs 141, personality traits 142, hobbies 143, other relatives 144, other friends 145, parents of friends 146, school information 147, teacher information (for each teacher) 148, tutor information 149, mentor information 150, information about your domestic employees 151, after school hangouts 152, neighbor associations 153, job and volunteer information 154, summer camp information 155 and sport participation information 156. The list continues with FIG. 6.

Referring to FIG. 6, another continuation of the data entry user interface 160 of the present invention is shown. This continuation screen 160 is either a separate screen/web-page or a continuation accessed by scrolling. It contains more special information regarding the person/child. The additional list of data includes, but is not limited to, church/youth groups 161, organizations 162, lessons 163 (e.g. music, dance), home maintenance staff 164, strangers 165 and known sex offenders 166. It is appreciated that, during data entry, the parent or guardian of the person/child is much more likely to accurately remember and enter the above information than when the parent or guardian is under the duress of a lost or abducted person/child.

In a pre-abduction situation, a guardian is likely to remember the name of the class bully 125 or the make/model of an estranged spouse's vehicle 126 but, sitting in the police station and under extreme stress, the guardian is less likely to recall many of the details requested in the present invention. Furthermore, some of the details are not always readily available when such an event occurs. Modern X-rays and dental records are digitally stored and, upon request, emailed to the parent/guardian for upload into the database 46 before an event occurs. After the event occurs, such records are often locked in dental or medical offices or archived and are not quickly available, especially when such offices are closed unless they available through the present invention.

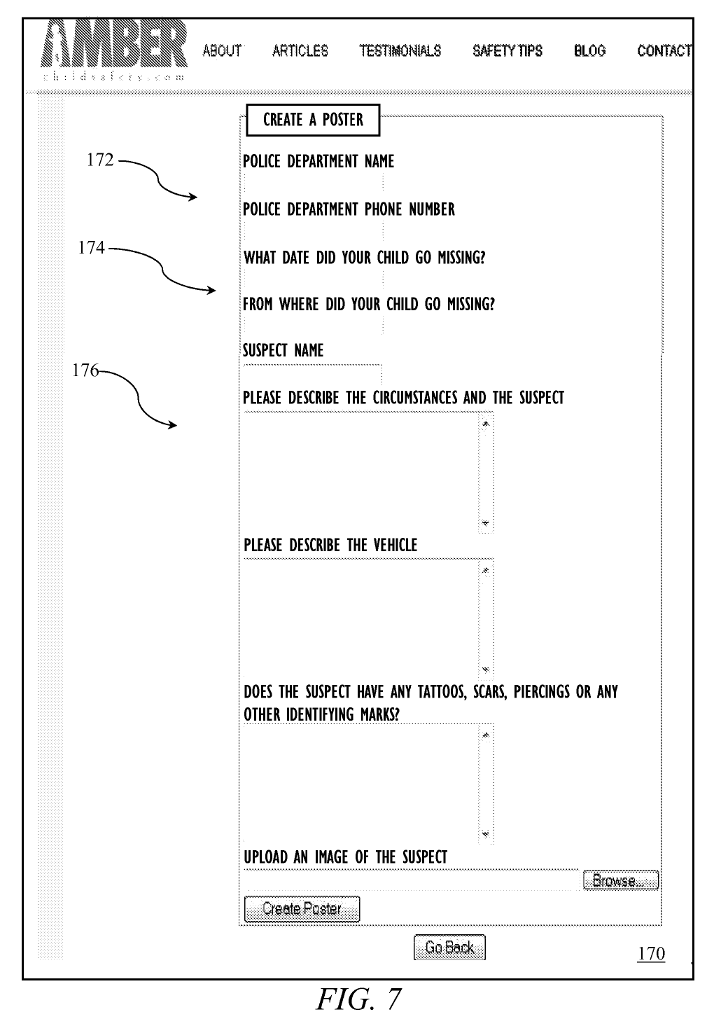

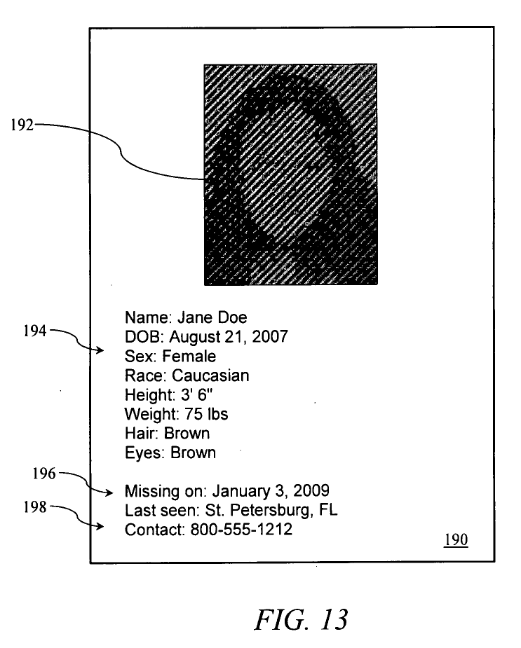

Referring to FIG. 7, a typical poster creation user interface 170 of the present invention is shown. Posters 190 (see FIG. 13) hung in various public locations (markets, post office, banks, etc) are well known ways to aid in the identifying and locating a missing person/child. Such posters 190 often include a photograph 192 and descriptive information 194 (see FIG. 13). Once an abduction is suspected, it is crucial to make such posters 190 visible to as many people in the surrounding community as possible to improve the chances of recovering the missing person/child. The longer it takes to disseminate this information (picture/text), the further away the person/child might be.

Prior to the present invention, it often took days or even weeks before the poster 190 is produced and disseminated, especially when the person/child and/or parent/guardian is out-of-town, having limited access to the person/child's photographs. Even when home, the parent/guardian is often too distraught to think clearly, let alone to be able to gather information and design such a poster 190.

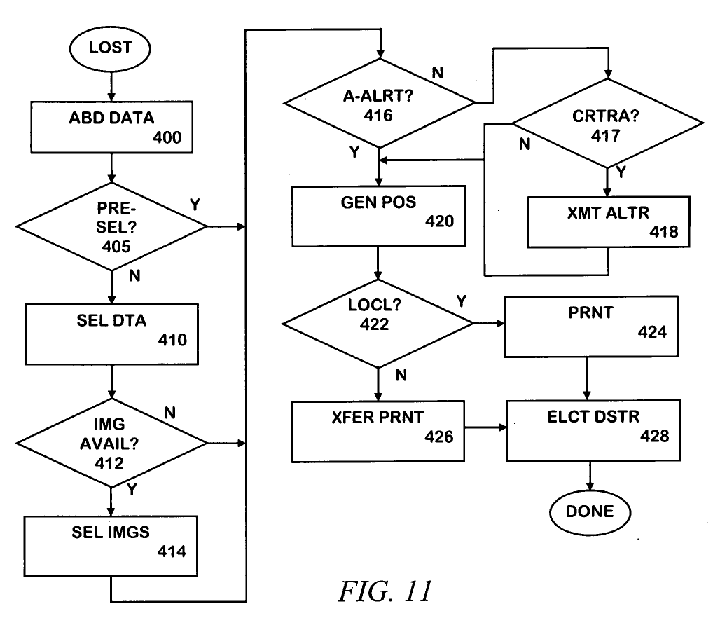

The present invention automates this process using information from the person/child database 46 augmented with information regarding the abduction such as the locality's police department information 172, information regarding when and where the abduction occurred 174 and suspect information 176 (e.g. circumstances, vehicle, suspect identification, image of the suspect). This information is often readily available from the police department and, once entered in the user interface 170, the poster 190 is created and ready for printing and/or electronic distribution (see FIG. 11).

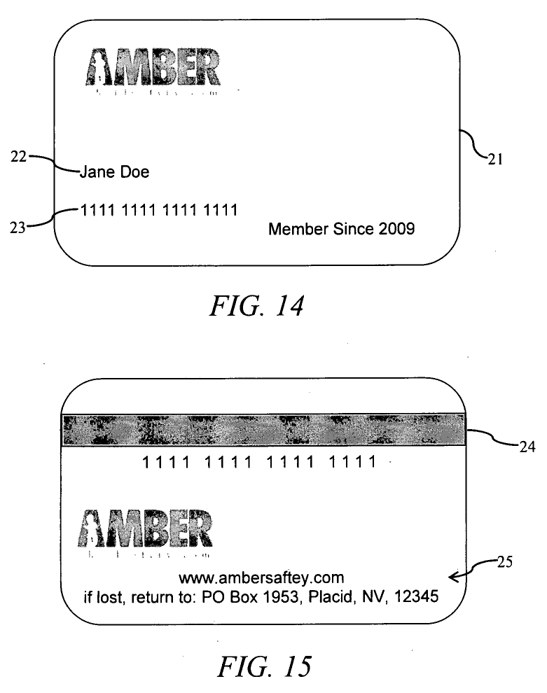

Referring to FIG. 8, a flow chart of the account access and data entry process of the present invention is shown. The present invention begins with either an existing user logging onto the service 200 or a new user creating an account 202. When the new user creates an account 202, in some embodiments, the new user is issued 204 a card 21 containing access information (see FIGS. 14 and 15). It is anticipated that the card 21 be convenient for carrying on the person of the parent or guardian. In some embodiments, the card includes a data stripe 24 to improve access time (see FIG. 15).

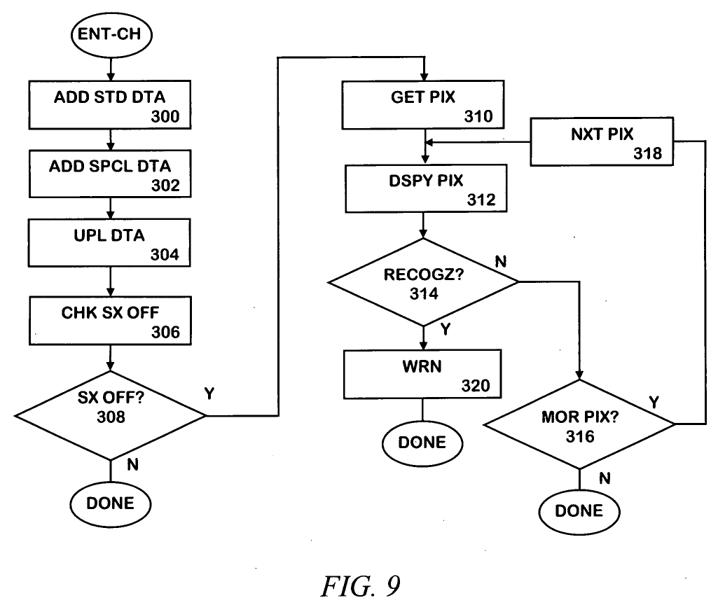

Once the user logs in 200 or creates a new account 202, one option is to add information regarding one or more persons/children 206. In this, the first person/child is selected/named 208 then data is entered/uploaded for that person/child 210 (see FIG. 9). The next person/child is selected 212 and if there is another person/child 214, data is entered/uploaded for that person/child 210, etc. If not, the entry/editing is done.

Referring to FIG. 9, a flow chart of person/child data entry process of the present invention is shown. Data entry for the person/child includes entering the typical information 300 regarding the child such as name, age, address, height, weight, etc. Data entry for the person/child further includes entering special information/data 302 such as nicknames, the route they take home from school, bus driver information, etc. Data entry for the person/child further includes uploading special information/data 304 such as images of friends, x-rays, dental records, images of tattoos, sound-bites, etc.

The data entry of special data 302 includes names of many individuals in the person/child's life. In embodiments in which the system of the present invention has access to any criminal records 44, each of the names is checked 306 to see if the name is in the criminal records 44 (e.g. is one of the names in a list of local sex offenders).

If any name is found to have one or more associated matches 308 from the criminal records 44, further processing is performed to make a positive identification since many names are common between those convicted of a crime (e.g. sex offender) and perfectly innocent people. This is done, for example, by accessing an image of the first possible criminal 310 and displaying the image 312 then asking 314 the user if the image is that of the person named during data entry. If the user recognizes the person in the picture 314 (e.g. the person named is a possible criminal), a warning is made 320. The warning is anticipated to include a message to the user informing the user of the fact that the person named is or might be a criminal or registered sex offender. In some embodiments, in cases in which the criminal or registered sex offender has an outstanding warrant, information related to their location is forwarded to the appropriate authorities.

If the user does not recognize the person in the picture 314, it is determined if additional pictures of the same or another named person are available 316. If more pictures are available, a next picture of the potential criminal/sex offender is accessed 318 and the method continues with displaying the picture 312.

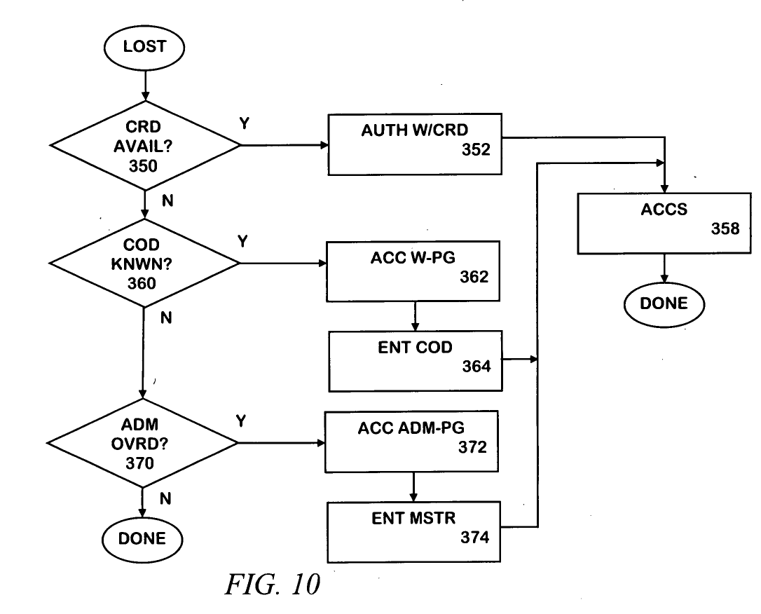

Referring to FIG. 10, a flow chart of the data access process of the present invention is shown. This process is likely executed when a person/child is believed to be missing or abducted. In embodiments in which cards 21 are issued to users, a test is made to determine if a card 21 is available 350 (e.g. a prompt “Is the card available?” and response “yes/no”). If the card 21 is available (e.g. in the parent or guardian's wallet), access authorization is performed 352 using data on the card 21. In embodiments in which a police station has a card reader capable of reading the card 21, the card 21 is swiped to gain access to the data/information 46. In embodiments in which a police station does not have a card reader capable of reading the card 21, the account information from the card 21 is used to gain access to the data/information 46. It is anticipated, for security reasons, that additional information is required to gain access to the person/child data/information 46 including, but not limited to, one or a combination of: a personal identification number (pin), a password, answering pre-determined questions, a fingerprint, a voice sample, a retinal scan, etc. Once the user is authorized/verified against stored security data 42, the person/child data 46 is made available to the local law enforcement agency(s) 358.

If the card 21 is not available 350, a test is made to determine if access information is known 360 by the user (e.g. a prompt “Enter username?” and the user enters their username). If the user remembers their logon information 360, an amber security web page is accessed 362 and the credentials are entered 364 to gain access to the person/child data 46. This includes, but is not limited to, one or a combination of: a username, a personal identification number (pin), a password, answering pre-determined questions, a fingerprint, a voice sample, a retinal scan, etc. Once the user is verified, the person/child data 46 is made available to the local law enforcement agency(s) 358.

If the user cannot remember their logon information 360, an amber security administrative web page is accessed 372 and the credentials are entered 374 to gain access to the person/child data 46. It is anticipated that, in some embodiments, this bypass mechanism requires additional security to access the person/child data 46 including, but not limited to, a law enforcement agency identifier, a law enforcement agency password, a recognized biometric reading of a law enforcement employee, verbal interaction with trusted individuals associated with the service, etc. Once the law enforcement agency is verified, the person/child data 46 is made available to the local law enforcement agency(s) 358.

Referring to FIG. 11, a flow chart of the poster generation process of the present invention is shown. Posters 190 (see FIG. 13) hung in various public locations (markets, post office, banks, etc) are well known ways to aid in the identifying and locating a missing person/child. Such posters 190 often include a photograph and descriptive information (see FIG. 13). Once an abduction (or other loss such as a child is lost) is suspected, it is crucial to make such posters 190 visible to as many people in the surrounding community as possible to improve the chances of recovering the missing person/child. The longer it takes to disseminate this information (picture/text), the further away the person/child might be.

The present invention automates the process of producing posters using information from the person/child database 46 augmented with information (see FIG. 7) regarding the abduction. After logging into the system (see above), the user enters data 400 such as the locality's police department information 172, information regarding when and where the abduction occurred 174 and suspect information 176 (e.g. circumstances, vehicle, suspect identification, image of the suspect). This information is often readily available from the police department (e.g. police report), once entered in the user interface 170.

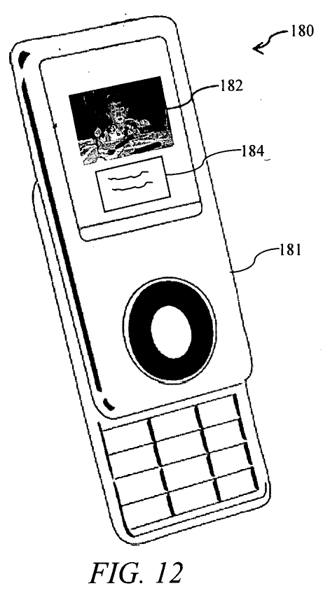

If the user has pre-set data 405 for poster generation (e.g. pre-determined which photograph is to be used), a test is made to determine if an automated alert is available 416. If an automated alert 416 is available, the situation is tested to make sure it meets local and/or state criteria 417 and, if so, data for the poster is formatted and transmitted to subscribers 418 (see FIG. 12). The situation is tested to prevent a glut of amber alerts issued when, for example, a child is visiting a neighbor and a parent, not seeing the child, panics.

Next, the poster 190 is created 420 for printing and/or electronic distribution. Next it is determined if the user will use a local printer 422. If using a local printer 422, the poster is sent to the local printer 424 for printing one or more copies. If using a remote service for printing 422, the poster image is sent/transferred 426 to a remote printing service to print a number of posters.

In either case, after printing 424 or transferring 426, in some embodiments, the poster is electronically distributed 428 to friends, family, neighbors, schools, etc.

If the user did not pre-select data and images 405, the user selects data 410 that is to be included on the poster 190. If one or more image is available 412, the user selects the image(s) 414 to be included on the poster 190. As above, a test is then made to determine if an automated alert is available 416. If an automated alert 416 is available, the situation is tested to make sure it meets local and/or state criteria 417 and, if so, data for the poster is formatted and transmitted to subscribers 418 (see FIG. 12). The situation is tested to prevent a glut of amber alerts issued when, for example, a child is visiting a neighbor and a parent, not seeing the child, panics.

Next, the poster 190 is created 420 for printing and/or electronic distribution. Next it is determined if the user will use a local printer 422. If using a local printer 422, the poster is sent to the local printer 424 for printing one or more copies. If using a remote service for printing 422, the poster image is sent/transferred 426 to a remote printing service to print a number of posters.

In either case, after printing 424 or transferring 426, in some embodiments, the poster is electronically distributed 428 to friends, family, neighbors, schools, etc.

Referring to FIG. 12, a perspective view of a cell phone showing an alert 180 of the present invention is shown. In this, an alert 180 is sent to and displayed on a device 181 such as a cell phone. The alert 180 includes information similar to that of the poster 190, although in some instances, abbreviated or reduced to match the display capabilities of the devices 181. The alert 180 includes, but is not limited to, a picture 182 of the missing person/child and text 184 describing the missing person/child.

The alert 180 is sent to a list of device subscribers. In some embodiments, the list of cell phone subscribers is associated with the user. In some embodiments, the list of cell phone subscribers is associated with a geographic region. In some embodiments, the list of cell phone subscribers is associated with a particular service provider (e.g. a cell phone service provider). In some embodiments, the list of cell phone subscribers is associated with customers of a particular service provider (e.g. a cell phone service provider) that have opted to receive such alerts 180. Combinations of these embodiments are anticipated such at the list of cell phone subscribers is associated with a geographic region that is serviced by a particular service provider.

In one embodiment of the present invention, the service providers provide the alerts 180 as an enticement to customers in return for considerations by the customers such as extending their contract, adding additional lines, upgrading service, upgrading equipment, etc.

Referring to FIG. 13, a plan view of a typical generated poster 190 of the present invention is shown. The generated poster 190 is similar to prior posters created after a person/child is missing and has information such as a picture 192 of the person/child, data 194 regarding the person/child, data regarding the circumstances of when the person/child was lost 196, contact information 198, perpetrator information (vehicle identification, etc—not shown in FIG. 13), etc.

Referring to FIG. 14, a front plan view of a typical user identification card 21 of the present invention is shown. Although shown to conform to credit/debit card size and shape requirements, the card 21 is of any shape and form including, but not limited to, key-chain sized cards 21. As shown, the front of the card 21 has identification information 22 and account information 23. The account information is used to logon and access the child data 46 associated with the particular user 22.

Referring to FIG. 15, a rear plan view of a typical user identification card of the present invention is shown. Although shown to conform to credit/debit card size and shape requirements, the card 21 is of any shape and form including, but not limited to, key-chain sized cards 21. In embodiments in which the card 21 conforms to credit card standards, the back of the card 21 has identification information encoded into, for example, a magnetic stripe 24. The back of the card 21 has, optionally; other printed information 25 such as the web site URL for accessing the child data 46 and an address in case the card is lost. The account information encoded on the card 21 is used by law authorities to logon and access the child data 46 associated with the particular user 22. Although shown as a magnetic stripe 24, any form of digital encoding of the account information onto or into the card 21 is anticipated including, but not limited to, radio frequency identification tags, holograms, bar codes and smart card technology.

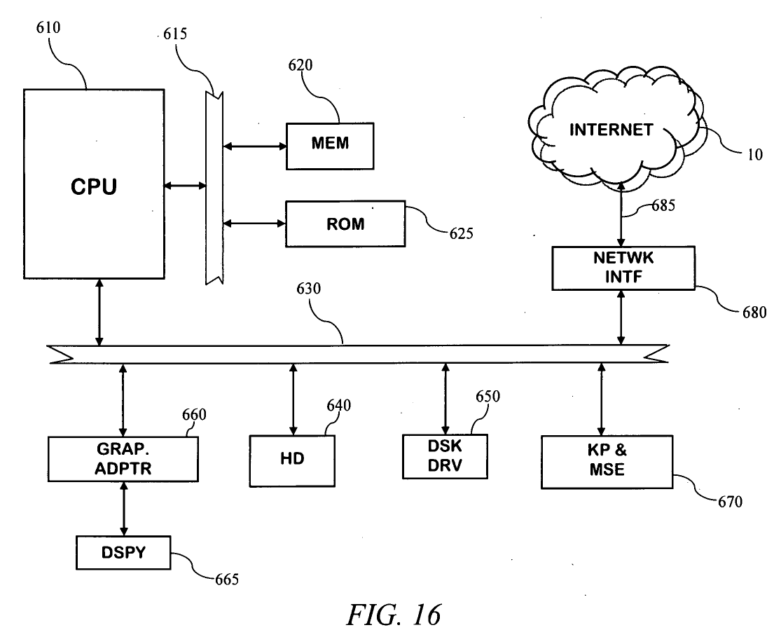

Referring to FIG. 16, a schematic view of a typical computer system of the present invention is shown. The example computer system represents a typical computer system used as the server 40 and/or the user terminal devices 20. The example computer system is shown in its simplest form, having a single processor. Many different computer architectures are known that accomplish similar results in a similar fashion and the present invention is not limited in any way to any particular computer system. The present invention works well utilizing a single processor system as shown in FIG. 16, a multiple processor system where multiple processors share resources such as memory and storage, a multiple server system where several independent servers operate in parallel (perhaps having shared access to the data or any combination). In this, a processor 610 is provided to execute stored programs that are generally stored for execution within a memory 620. The processor 610 can be any processor or a group of processors, for example an Intel Pentium-4® CPU or the like. The memory 620 is connected to the processor by a memory bus 615 and can be any memory 620 suitable for connection with the selected processor 610, such as SRAM, DRAM, SDRAM, RDRAM, DDR, DDR-2, etc. Firmware is stored in firmware storage 625 that is also connected to the processor 610 through the memory bus 615. The firmware storage is anticipated to include initialization software known as BIOS. This initialization software usually operates when power is applied to the system or when the system is reset.

Also connected to the processor 610 is a system bus 630 for connecting to peripheral subsystems such as a network interface 680, a hard disk 640, a disk drive (e.g. DVD) 650, a graphics adapter 660 and a keyboard/mouse 670. The graphics adapter 660 receives commands and display information from the system bus 630 and generates a display image that is displayed on the display 665.

In general, the hard disk 640 may be used to store programs, executable code and data persistently, while the disk drive 650 may be used to load CD/DVD/Blueray disk having programs, executable code and data onto the hard disk 640. These peripherals are examples of input/output devices, persistent storage and removable media storage. Other examples of persistent storage include core memory, FRAM, flash memory, etc. Other examples of removable media storage include CDRW, DVD, DVD writeable, Blueray, compact flash, other removable flash media, floppy disk, ZIP®, etc. In some embodiments, other devices are connected to the system through the system bus 630 or with other input-output connections. Examples of these devices include printers; graphics tablets; joysticks; and communications adapters such as modems and Ethernet adapters.

The network interface 680 connects the computer-based system to the Internet 10 through a link 685 which is, preferably, a high speed link such as a cable broadband connection, a Digital Subscriber Loop (DSL) broadband connection, a T1 line or a T3 line.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for aiding in finding a missing person, the system comprising:
a server computer, the server computer having a data storage area;
a database of information stored in the data storage area, the information is related to a person, the information is organized in an account, and the information comprises typical information and specialized information; and
a client computer operatively coupled to the server computer, the client computer having access to the information through a secured connection to the server computer;
wherein the typical information comprises at least a name of the person, a data of birth of the person and a race of the person, and
wherein the specialized information comprises at least five data selected from the group comprising images of family and friends of the person, X-ray images of the person, images of scars of the person, images of birthmarks of the person, images of tattoos of the person, images of piercings of the person, images of fingerprints of the person and images of dental records of the person.

2. The system for aiding in finding the missing person of claim 1, wherein the specialized information further includes information related to custody records of the person's family information related to threats made to the person, text describing internet harassments of the person, recently ended relationships of the person, lists of doctors of the person, lists of medications prescribed to the person, lists of medical conditions of the person, names of school bus drivers of busses taken by the person, computer profiles of the person, baby sitter information of a babysitter of the person, baby sitting jobs the person has had, personality traits of the person, hobbies of the person, other relatives of the person, other friends of the person, parents of friends of the person, school information regarding the person, teacher information of teachers of the person, tutor information of tutors of the person, mentor information of mentors of the person, information about domestic employees working in the home of the person, after school hangouts of the person, neighbor associations of the person, job and volunteer information relating to the person, summer camp information of the person and sport participation information of the person.

3. The system for aiding in finding the missing person of claim 1, wherein the specialized information further comprises church/youth groups to which the person belongs, organizations to which the person belongs, lessons that the person takes, strangers that have been in contact with the person and known sex offenders in the locality of the person.

4. The system for aiding in finding the missing person of claim 1, further comprising account maintenance software running on the server computer that accepts the information from the user computer and stores the information in the database of information.

5. The system for aiding in finding the missing person of claim 4, wherein the server computer has access to criminal records.

6. The system for aiding in finding the missing person of claim 5, whereas as the account maintenance software accepts the information from the user computer, the account maintenance software looks up the information in the criminal records.

7. The system for aiding in finding the missing person of claim 6, wherein the criminal records include images and whereas the account maintenance software sends the images to the client computer and the images are displayed at the client computer.

8. The system for aiding in finding the missing person of claim 7, whereas an indication regarding the images that are displayed at the client computer is sent from the client computer to the server computer and, if the indication is affirmative, a warning is issued from the account maintenance software.

9. The system for aiding in finding the missing person of claim 1, whereas a card is sent to a user of the account, the card including account access information regarding the account.

10. The system for aiding in finding the missing person of claim 9, whereas a card is sent to a user of the account, the card is used to create the secure connection.

11. A method of providing a service that aids in finding the missing person comprising:
providing a server computer having a data storage area and a database of information stored in the data storage area, the information is related to a person, the information is organized into accounts, and the information contains typical information related to the person and specialized information related to the person;
accepting a fee from a customer; and
in return for the fee, accepting the information from the customer and storing the information in an account for the customer;
wherein the typical information comprises at least a name of the person, a data of birth of the person and a race of the person, and
wherein the specialized information comprises at least five data selected from the group comprising images of family and friends of the person, X-ray images of the person, images of scars of the person, images of birthmarks of the person, images of tattoos of the person, images of piercings of the person, images of fingerprints of the person and images of dental records of the person.

12. The method of claim 11, further comprising accepting an additional fee from the customer, in return for the additional fee, further maintaining and providing access to the information.

13. The method of claim 11, wherein the specialized information further includes information related to custody records of the person's family information related to threats made to the person, text describing internet harassments of the person, recently ended relationships of the person, lists of doctors of the person, lists of medications prescribed to the person, lists of medical conditions of the person, names of school bus drivers of busses taken by the person, computer profiles of the person, baby sitter information of a babysitter of the person, baby sitting jobs the person has had, personality traits of the person, hobbies of the person, other relatives of the person, other friends of the person, parents of friends of the person, school information regarding the person, teacher information of teachers of the person, tutor information of tutors of the person, mentor information of mentors of the person, information about domestic employees working in the home of the person, after school hangouts of the person, neighbor associations of the person, job and volunteer information relating to the person, summer camp information of the person and sport participation information of the person.

14. The method of claim 11, wherein the specialized information further comprises church/youth groups to which the person belongs, organizations to which the person belongs, lessons that the person takes, strangers that have been in contact with the person and known sex offenders in the locality of the person.

15. The method of claim 11, wherein the server has access to criminal records and whereas the step of accepting the information from the customer includes a step of looking up the information in the criminal records.

16. The method of claim 15, whereas the step of looking up the information further comprises the step of, if the step of looking up the information is successful in locating a criminal, displaying at least one image of the criminal from the criminal records to the customer.

17. The method of claim 16, wherein the criminal is a sex offender.

18. The method of claim 11, further comprising issuing an identification card to the customer after the step of accepting the fee, the identification card containing access information to be used by the customer when accessing the account.

19. A system for aiding in finding a missing person, the system comprising:
a server computer, the server computer having a data storage area;
a database of information stored in the data storage area, the information is related to a person, the information is organized in an account, and the information comprises typical information and specialized information;
a client computer operatively coupled to the server computer, the client computer having access to the information through a secured connection to the server computer;
account maintenance software running on the server computer, the account maintenance software accepting the information from the client computer and storing the information in the database of information and the account maintenance software providing the information from the database of information to authorized users of the account;
wherein the typical information comprises at least a name of the person, a data of birth of the person and a race of the person, and
wherein the specialized information comprises X-ray images of the person, images of scars of the person, images of birthmarks of the person, images of fingerprints of the person and images of dental records of the person.

20. The system for aiding in finding the missing person of claim 19, wherein the specialized information further includes information related to custody records of the person's family information related to threats made to the person, text describing internet harassments of the person, recently ended relationships of the person, lists of doctors of the person, lists of medications prescribed to the person, lists of medical conditions of the person, names of school bus drivers of busses taken by the person, computer profiles of the person, baby sitter information of a babysitter of the person, baby sitting jobs the person has had, personality traits of the person, hobbies of the person, other relatives of the person, other friends of the person, parents of friends of the person, school information regarding the person, teacher information of teachers of the person, tutor information of tutors of the person, mentor information of mentors of the person, information about domestic employees working in the home of the person, after school hangouts of the person, neighbor associations of the person, job and volunteer information relating to the person, summer camp information of the person, sport participation information of the person, images of family and friends of the person, images of tattoos of the person and images of piercings of the person.

21. The system for aiding in finding the missing person of claim 19, wherein the server computer has access to criminal records and whereas the account maintenance software looks up the information in the criminal records, determining if any person named in the information has a matching criminal record in the criminal records.

22. The system for aiding in finding the missing person of claim 19, whereas a card is sent to a customer owning the account, the card includes account access information regarding the account.
